(19) United States
(12) Patent Application Publication
(10) Pub. No.: US 2024/0418516 A1
(43) Pub. Date: Dec. 19, 2024

(54) CONTROL DEVICE AND CONTROL METHOD

(71) Applicant: TOYOTA JIDOSHA KABUSHIKI KAISHA, Toyota-shi, Aichi-ken (JP)

(72) Inventors: Makoto AKAHANE, Yokohama-shi (JP); Yu NAGATA, Chofu-shi (JP); Tomokazu MAYA, Nagoya-shi (JP); Masaaki TOMIYA, Urayasu-shi (JP); Yuko MINETA, Chofu-shi (JP); Kayo TSUMOTO, Nisshin-shi (JP); Shinichi NIWA, Nagakute-shi (JP); Satoshi KOMAMINE, Nagoya-shi (JP)

(73) Assignee: TOYOTA JIDOSHA KABUSHIKI KAISHA, Toyota-shi, Aichi-ken (JP)

(21) Appl. No.: 18/656,218

(22) Filed: May 6, 2024

(30) Foreign Application Priority Data
Jun. 15, 2023 (JP) 2023-098752

(51) Int. Cl. G01C 21/34

(52) U.S. Cl. CPC G01C 21/3415; G01C 21/3492

(57) ABSTRACT

The control device includes a control unit configured to obtain information regarding a congestion level of at least two locations in which an event is held, and determine a transport route in which mobility moving between the at least two locations transports passengers based on the obtained information regarding the congestion level.

### CROSS-REFERENCE TO RELATED APPLICATION

This application claims priority to Japanese Patent Application No. 2023-098752 filed on Jun. 15, 2023, incorporated herein by reference in its entirety.

### BACKGROUND

### 1. Technical Field

The present disclosure relates to a control device and a control method.

### 2. Description of Related Art

In Japanese Unexamined Patent Application Publication No. 2021-089161 (JP 2021-089161 A), it is disclosed to select, among a plurality of tourist routes, a tourist route in which a direction passing through a plurality of tourist spots and a direction in which the vehicle travels coincide with each other, that overlaps at least a part of a scheduled travel route, and in which the length of the overlapping route is the longest.

### SUMMARY

In an area where an event is held, such as an event site, a congestion degree changes every moment. Therefore, an optimum route of a bus moving in the area or between areas changes from time to time.

It is an object of the present disclosure to be able to adjust, depending on a congestion state of an area where an event is held, a route of transporting a passenger in the area or between areas.

A control device according to the present disclosure includes a control unit configured to:
acquire information on congestion degrees of at least two locations where an event is held; and
determine a transportation route for a mobility that moves between the at least two locations to transport a passenger, based on the acquired information on the congestion degrees.

A control method according to the present disclosure includes:
acquiring, by a control unit, information on congestion degrees of at least two locations where an event is held; and
determining, by the control unit, a transportation route for a mobility that moves between the at least two locations to transport a passenger, based on the acquired information on the congestion degrees.

According to the present disclosure, it is possible to adjust, depending on a congestion state of an area where an event is held, a route for transporting a passenger in the area or between areas.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of a mobility control system according to an embodiment of the present disclosure;

FIG. 2 is a block-diagram illustrating a configuration of a control device according to an embodiment of the present disclosure; and

FIG. 3 is a flowchart illustrating an operation of a control device according to an embodiment of the present disclosure.

### DETAILED DESCRIPTION OF EMBODIMENTS

Hereinafter, an embodiment of the present disclosure will be described with reference to the drawings.

In each drawing, the same or corresponding portions are denoted by the same reference signs. In the description of the present embodiment, description of the same or corresponding components will be appropriately omitted or simplified.

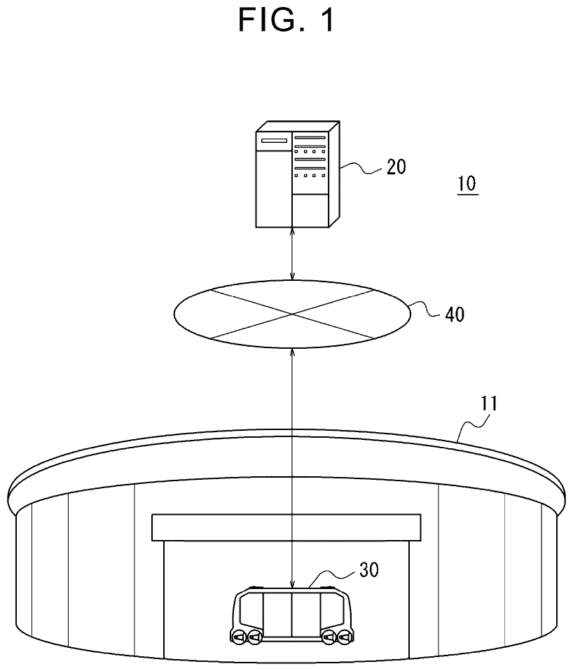

Referring to FIG. 1, a configuration of a mobility control system 10 according to the present embodiment will be described.

The mobility control system 10 includes a control device 20 and a mobility 30. The control device 20 can communicate with the mobility 30 via the network 40.

The control device 20 is a computer installed in a facility such as a data center. The control device 20 is, for example, a server belonging to a cloud computing system or other computing systems. The control device 20 is operated by, for example, a business operator that operates an event.

The mobility 30 may be any type of vehicle, such as, for example, a gas-powered vehicle, a die-powered vehicle, a HEV, PHEV, BEV, or a FCEV. “HEV” is an abbreviation for hybrid electric vehicle. “PHEV” is an abbreviation for plug-in hybrid electric vehicle. “BEV” is an abbreviation for battery electric vehicle. “FCEV” is an abbreviation for fuel cell electric vehicle. The mobility 30 is AV in this embodiment, but may be driven by a driver or may be automated at any level. AV stands for autonomous vehicle. The level of autonomous driving is, for example, one of levels 1 to 5 in the SAE leveling, for example. “SAE” is an abbreviation for Society of Automotive Engineers. The mobility 30 may be MaaS dedicated vehicles. MaaS is an abbreviation for Mobility as a Service.

The network 40 includes the Internet, at least one WAN, at least one MAN, or any combination thereof. WAN is an abbreviation for wide area network. MAN is an abbreviation for metropolitan area network. The network 40 may include at least one wireless network, at least one optical network, or any combination thereof. The wireless network is, for example, an ad hoc network, a cellular network, a wireless LAN, a satellite communication network, or a terrestrial microwave network. The term “LAN” is an abbreviation for “local area network”.

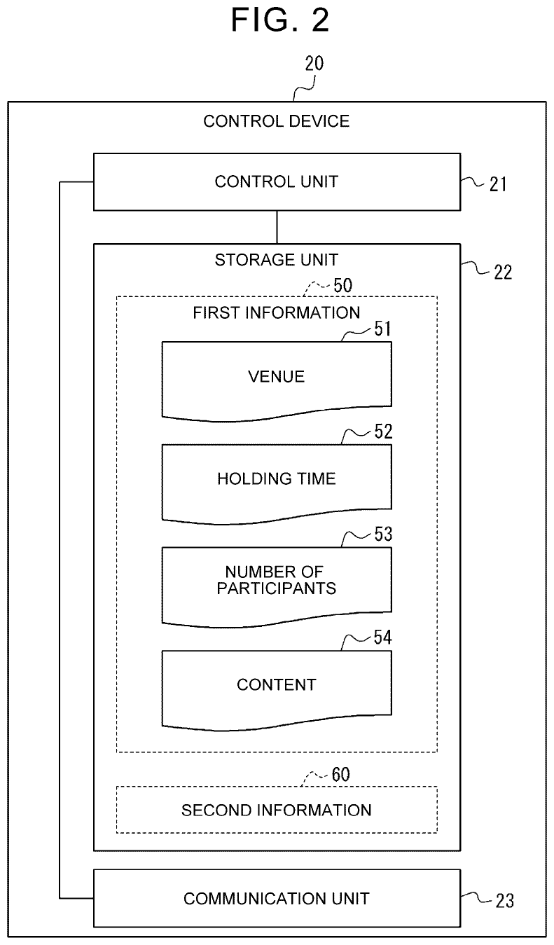

Referring to FIG. 1 and FIG. 2, an outline of the present embodiment will be described.

The control device 20 acquires, by the control unit 21, the second information 60 regarding the congestion degree of at least two places where the event is held. Events include, for example, exhibitions, trade fairs, food events, or product exhibitions. In the present embodiment, the second information 60 is information on the congestion level of each booth in the area 11 where the event is held. That is, each location of “at least two locations” corresponds to a booth. The area 11 is, for example, an event venue such as an arena. Mobility 30 moves between at least two booths in area 11. Mobility 30 may orbit a route that includes three or more booths in area 11. Based on the acquired second information 60, the control unit 21 of the control device 20 determines a transport route through which the mobility 30 transports passengers.

According to the present embodiment, it is possible to adjust the route for transporting passengers in the area 11 according to the congestion state of the area 11. For example, it is possible to reduce congestion by suppressing excessive user congestion in a specific booth.

In the present embodiment, the control device 20 acquires the first information 50 related to the event by the control unit 21. The control device 20 acquires the second information 60 by predicting the future congestion degree of each booth in the area 11 based on the acquired first information 50.

In the present embodiment, the first information 50 includes various kinds of information such as an event venue 51, time 52, a number of participants 53, or contents 54. The first information 50 preferably includes not only past and current information but also future information. That is, it is desirable for the control device 20 to predict the future congestion level of each booth in the area 11 based on such future information. The past information includes, for example, a congestion level when an event similar to an event scheduled to be performed in each booth is performed in the past, such as the same day of the previous year. The current information includes, for example, a profile such as a pre-subscription status to an event scheduled to be performed at each booth, or information about the degree of interest of the user obtained at the time of the pre-subscription, or a job type of the individual user. Future information includes, for example, the content of the event scheduled to be performed at each booth, or the schedule of the individual user, such as an A booth at 11:00, a lunch at 12:00, and a B booth at 13:00. When the event is held on multiple days, the number of visitors tends to be statistically a bowl curve, and tends to be the first day and the last day. Therefore, the control device 20 may predict the congestion level on the first day from the number of visitors or registered persons in the previous year, and the congestion level on and after the second day may correct the predicted number from the number of persons on the first day to predict a more correct number of persons.

Content of events that are running or scheduled to take place in a booth that is crowded and difficult for the user to visit may be provided within mobility 30. A user may be allowed to meet or lunch within mobility 30.

As a modification of the present embodiment, the control device 20 may acquire the second information 60 by observing the current congestion degree of each booth in the area 11, instead of predicting the future congestion degree of each booth in the area 11.

As another variation of this embodiment, the second information 60 may be information regarding the congestion level of at least two areas in which the event is to be held. That is, each location of “at least two locations” may correspond to an area. Each area is, for example, an event venue such as an arena. The control device 20 may acquire the second information 60 by predicting the future congestion degree of each area. Alternatively, the control device 20 may acquire the second information 60 by observing the current congestion degree of each area. In this variation, mobility 30 moves between at least two areas. Mobility 30 may orbit a route that includes three or more areas.

According to this modification, it is possible to adjust the route for transporting passengers between the areas according to the congestion situation of each area. For example, it is possible to reduce congestion by suppressing excessive user congestion at a specific event venue.

Referring to FIG. 2, a configuration of the control device 20 according to the present embodiment will be described.

The control device 20 includes a control unit 21, a storage unit 22, and a communication unit 23.

The control unit 21 includes at least one processor, at least one programmable circuit, at least one dedicated circuit, or any combination thereof. The processor is a general-purpose processor such as a CPU or a GPU, or a dedicated processor specialized for a specific process. The term “CPU” is an abbreviation for “central processing unit”. The term “GPU” is an abbreviation for “graphics processing unit”. The programmable circuit is, for example, an FPGA. The term “FPGA” is an abbreviation for “field-programmable gate array”. The dedicated circuit is, for example, an ASIC. The term “ASIC” is an abbreviation for “application specific integrated circuit”. The control unit 21 performs processes related to the operation of the control device 20 while controlling each unit of the control device 20.

The storage unit 22 includes at least one semiconductor memory, at least one magnetic memory, at least one optical memory, or any combination thereof. The semiconductor memory is, for example, a RAM, a ROM, or a flash memory. The term “RAM” is an abbreviation for “random access memory”. The term “ROM” is an abbreviation for “read-only memory”. The RAM is, for example, an SRAM or a DRAM. The term “SRAM” is an abbreviation for “static random access memory”. The term “DRAM” is an abbreviation for “dynamic random access memory”. The ROM is, for example, an EEPROM. “EEPROM” is an abbreviation for electric ally erasable programmable read only memory. The flash memory is, for example, an SSD. “SSD” is an abbreviation for solid-state drive. The magnetic memory is, for example, an HDD. “HDD” is an abbreviation for hard disk drive. The storage unit 22 functions as, for example, a main storage device, an auxiliary storage device, or a cache memory. The storage unit 22 stores the information used for the operation of the control device 20 and the information obtained through the operation of the control device 20. In the present embodiment, at least the first information 50 and the second information 60 are stored in the storage unit 22.

The communication unit 23 includes at least one communication module. The communication module is, for example, a module compliant with a wired LAN communication standard such as Ethernet (registered trademark) or a wireless LAN communication standard such as IEEE802.11. “IEEE” is an abbreviation for Institute of Electrical and Electronics Engineers. The communication unit 23 communicates with the mobility 30. The communication unit 23 receives information used for the operation of the control device 20, and transmits information obtained through the operation of the control device 20.

The function of the control device 20 is realized by executing the program according to the present embodiment with the processor serving as the control unit 21. That is, the function of the control device 20 is realized by software. The program causes the computer to perform the operation of the control device 20 such that the computer functions as the control device 20. That is, the computer functions as the control device 20 by performing the operation of the control device 20 in accordance with the program.

The program can be stored in a non-transitory computer-readable medium. The non-transitory computer-readable medium is, for example, a flash memory, a magnetic recording device, an optical disc, an opto-magnetic recording medium, or a ROM. The distribution of the program is carried out, for example, by selling, transferring, or renting a portable medium such as an SD card, a DVD, or a CD-ROM in which the program is stored. The term “SD” is an abbreviation for “secure digital”. The term “DVD” is an abbreviation for “digital versatile disc”. The term “CD-ROM” is an abbreviation for “compact disc read-only memory”. The program may be stored in the storage of the server and transferred from the server to other computers to distribute the program. The program may be provided as a program product.

The computer temporarily stores the program stored in the portable medium or the program transferred from the server in the main storage device, for example. The computer then causes the processor to read the program stored in the main storage device, and causes the processor to execute processes in accordance with the read program. The computer may read the program directly from the portable medium and execute processes in accordance with the program. The computer may execute the processes in accordance with the received program each time the program is transferred from the server to the computer. The processes may be executed by a so-called ASP service that realizes the function only by execution instruction and result acquisition without transferring the program from the server to the computer. The term “ASP” is an abbreviation for “application service provider”. The program includes information that is used for processing by electronic computers and equivalent to a program. For example, data that is not a direct command to a computer but has the property of defining the processing of the computer corresponds to the “data equivalent to a program”.

A part or all of the functions of the control device 20 may be realized by a programmable circuit or a dedicated circuit as the control unit 21. That is, a part or all of the functions of the control device 20 may be realized by hardware.

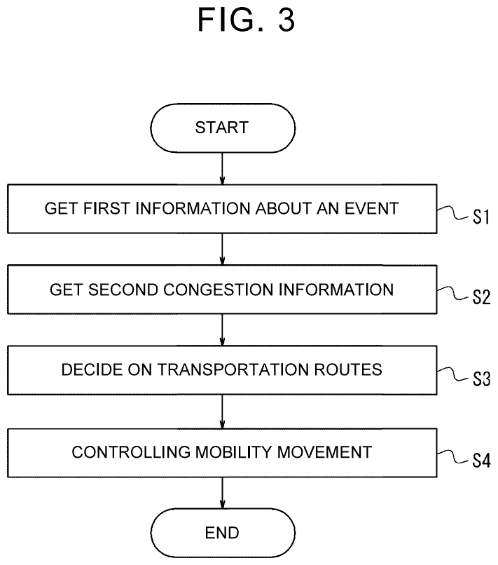

Referring to FIG. 3, the operation of the control device 20 according to the present embodiment will be described. The operation of the control device 20 corresponds to the control method according to the present embodiment. That is, the control methods according to the present embodiment include the steps of S4 from S1 shown in FIG. 3.

In S1, the control unit 21 acquires the first information 50. Specifically, the control unit 21 reads the first information 50 from the storage unit 22. The first information 50 is stored in the storage unit 22 in advance. Alternatively, the first information 50 may be acquired from an external storage via the communication unit 23 and then stored in the storage unit 22.

In S2, the control unit 21 acquires the second information 60. Specifically, the control unit 21 acquires the second information 60 by predicting the future congestion levels of the respective booths in the area 11 based on the first information 50 acquired by S1. The control unit 21 stores the acquired second information 60 in the storage unit 22. For example, the control unit 21 predicts attraction of customers to each booth in the event venue according to the event venue 51, the time 52, the number of participants 53, or the content 54 included in the first information 50. The time at which each booth in the event venue opens, the time at which the event starts at each booth, or in the case of a booth or event under a reservation system, the time of the reservation may be considered.

Instead of predicting the future congestion degree of each booth in the area 11, the control unit 21 may acquire the second information 60 by observing the current congestion degree of each booth in the area 11. For example, the control unit 21 may receive the captured images of the booths in the event hall via the communication unit 23 and analyze the received captured images to observe attractions to the booths.

In S3, the control unit 21 determines a transportation route through which the mobility 30 transports passengers based on the second information 60 acquired by S2. Specifically, the control unit 21 determines, as a transport route, a route for transporting more passengers to a booth with a lower congestion level. As a result, the congestion degree can be equalized.

In S4, the control unit 21 controls the mobility 30 to move the transportation route determined by S3. For example, the control unit 21 notifies the mobility 30 of the transport route via the communication unit 23, and moves the transport route to the mobility 30.

The steps from S1 to S4 are repeated. Therefore, the control device 20 can respond to a change in the congestion state in real time. When the control unit 21 detects a change in the congestion level, it is desirable to appropriately change the transport route even when the mobility 30 is moving.

The present disclosure is not limited to the embodiment described above. For example, two or more blocks shown in the block diagram may be integrated, or a single block may be divided. Instead of executing two or more steps shown in the flowchart in chronological order according to the description, the steps may be executed in parallel or in a different order, depending on the processing capacities of the devices that execute the steps, or as necessary. Other changes may be made without departing from the scope of the present disclosure.

What is claimed is:

1. A control device comprising a control unit configured to:
acquire information on congestion degrees of at least two locations where an event is held; and
determine a transportation route for a mobility that moves between the at least two locations to transport a passenger, based on the acquired information on the congestion degrees.

2. The control device according to claim 1, wherein the control unit acquires the information on the congestion degrees by observing current congestion degrees of the at least two locations.

3. The control device according to claim 1, wherein the control unit
acquires information on the event, and
acquires the information on the congestion degrees by predicting future congestion degrees of the at least two locations based on the acquired information on the event.

4. The control device according to claim 1, wherein the control unit determines, as the transportation route, a route for transporting more passengers to a location with a lower congestion degree from among the at least two locations.

5. A control method comprising:
acquiring, by a control unit, information on congestion degrees of at least two locations where an event is held; and
determining, by the control unit, a transportation route for a mobility that moves between the at least two locations to transport a passenger, based on the acquired information on the congestion degrees.
